(19) United States
(12) Patent Application Publication
(10) Pub. No.: US 2007/0104228 A1
(43) Pub. Date: May 10, 2007

(54) Asymmetric Differential Timing

(75) Inventors: Ron Cohen, Modiin (IL); Bar Gal-On, Modiin (IL); Zohar Peleg, Modiin (IL); David Brief, Modiin (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: RESOLUTE NETWORKS, LTD., Modiin (IL)

(21) Appl. No.: 11/555,283

(22) Filed: Nov. 1, 2006

Related U.S. Application Data
(60) Provisional application No. 60/734,781, filed on Nov. 9, 2005.

(51) Int. Cl. H04J 3/06

(52) U.S. Cl. 370/518

(57) ABSTRACT

A system and method for reconstructing a service clock between two, first and second subsystems communicating therebetween, comprising a first subsystem operative to generate first subsystem timestamps, a second subsystem operative to generate second subsystem timestamps at a second frequency different from the first timestamps, wherein the generations of both first and second timestamps are based on sampling of the service clock by a common clock available at both subsystems, and an aligner for arithmetically aligning the different first and second subsystem timestamps to reconstruct the service clock.

### CROSS REFERENCE TO RELATED APPLICATIONS

The present invention claims priority from U.S. Provisional Patent Application No. 60/734,781 filed Nov. 9, 2005, the content of which is incorporated herein by reference.

### FIELD OF THE INVENTION

The present invention relates generally to clock timing in telecom networks, and more particularly to differential timing in such networks.

### BACKGROUND OF THE INVENTION

Telecom networks are built to deliver data and clock (the latter referred to as ‘service clock’) from one end of the network to the other. Strict standards for the stability of the clock at the output of a telecom network are in place to guarantee the quality of the service delivered at the end points. A collection of methods called ‘differential timing’ can be used to deliver the service clock from one end of the network to the other, when both ends of the network have access to a stable clock traceable to the same source (referred to as a ‘common clock’).

An example for such a method involves delivery of a 1.544 Mbps DS1 circuit from one end of the telecom network to the other. DS1 is the lowest rate circuit within the Plesiochronous Digital Hierarchy (PDH). When Synchronous Digital Hierarchy (SDH) technology is used to deliver the DS1 from one location to the other, all the network devices transporting the DS1 are locked to the same clock (hence ‘synchronous’). Therefore, the difference between the DS1 clock and the common clock can be encoded within the bits of the SDH container carrying the DS1 bits across the SDH network, providing the telecom end point enough information to recover the original DS1 clock with adequate clock stability and performance.

When this DS1 (or any other time division multiplexed TDM signal) is transported over a network optimized for delivery of data, the DS1 bits can be encapsulated into packets and sent across the packet network to be reassembled and played out onto the outgoing DS1 interface. This technology is sometimes called ‘circuit emulation’, as the DS1 circuit is emulated over a packet network providing both ends of the network a DS1 interface as if it were carried over a ‘real’ SDH or PDH transport network.

The DS1 service clock needs to be recovered at the remote end of the packet network with adequate performance. When both ends of the packet network have access to a common clock, the well known method to deliver the difference in clock between the DS1 service clock and the common clock is to timestamp the packets carrying the DS1 bits with a timestamp derived from the common clock. The common method is to use a 32 bit timestamp in the Real-Time-Protocol (RTP) header for this purpose. The receiver matches the timestamp of the common clock in the incoming packets (referred to as “remote timestamp”) with its own timestamp generated by the common clock (referred as “local timestamp”) and uses a Phase-Locked Loop (PLL) to adapt the outgoing DS1 clock to maintain a constant difference between the local and remote timestamps.

DS1 (as well as other TDM signals) are bi-directional. When DS1 circuits are transported over the packet network, there are situations in which both ends of the network need to recover the clock from the remote end. When differential timing is used, the common practice is to use the same timestamp clock frequency to timestamp the outgoing packets. Hence, the current differential timing methods are symmetric.

FIG. 1 describes a simplified current practice symmetric differential timing system 100. System 100 includes a differential timing first subsystem 102 that includes a “sender” transmission function 103 (the subsystem thus acting as a single “sender”) and a second subsystem 108 that includes a “receiver” transmission function 109 (the subsystem thus acting as a single “receiver”). For simplicity, the transmission functions will be henceforth referred to simply as “sender” and “receiver”. In other words, FIG. 1 outlines essentially two communicating subsystems, a “sender” subsystem (102) and a “receiver” subsystem (108). This arrangement is by no means limiting, as in the most general sense, each subsystem may include both sender and receiver, more than one sender or more than one receiver. In general, any communication system will have at least one subsystem with a receiver. Note that “sender” and “receiver” refer both to functionalities as well as elements that can perform them, implemented in software, hardware or both. In normal practice, each subsystem includes both sender and a receiver.

As shown in FIG. 1, the sender subsystem includes a 1/N divider 104, a counter 106 and a frequency converter 118, interconnected as shown. When the sender subsystem includes more than one sender, all senders may be coupled to the same frequency converter. The receiver subsystem includes a controller 110, a counter 112, a 1/N divider 114, a controlled frequency generator (F-Gen) 116, and a frequency converter 120 interconnected as shown. When the receiver subsystem includes more than one receiver, all receivers may be coupled to the same frequency converter

In use, the first subsystem sender (or simply “sender”) samples N cycles of an incoming service clock (e.g. DS1 1544 kHz) with a common reference clock with frequency F3 (e.g. 19.44 MHz) and generates sender timestamps to be carried across the network to the receiver. A “reference clock with frequency F” is sometimes referred to herein simply as “reference clock F”, 1/N divider 104 generates a sample clock pulse every N cycles of the incoming service clock. Counter 106 value-increments each cycle of reference clock F3 and, each sample clock, generates a sender timestamp which holds the counter value at that time. The sender timestamp is sent to the receiver. Sender frequency converter 118 is used to convert an input frequency F1 (19.44 MHz) to the common reference clock frequency F3 (also 19.44 MHz in this example).

The second subsystem receiver (or simply “receiver”) uses F-Gen 116 for generation of the service clock (1544 kHz). The frequency of the clock generated by F-Gen is controlled by the controller. Exemplarily, F-Gen may be a Voltage Controlled Oscillator (VCO), which is an oscillator with a voltage controlled input. Change of the voltage level on its input changes the output frequency of the oscillator. There are many other well known ways to implement F-Gen. The output of the F-Gen is sampled using a circuit identical with that in sender 102 by sampling N cycles of the generated service clock with the common reference clock F3 to generate receiver timestamps. That is, 1/N divider 114 generates a sample clock pulse every N cycles of the generated service clock. Counter 112 value-increments each cycle of the reference clock and, each sample clock generates a receiver timestamp that holds the counter value at that time. This receiver timestamp is used by the controller to match against the received sender timestamp. Since both receiver and sender have access to the same reference clock, the receiver and sender timestamps should have a constant offset between them at any given time. Controller 110 compares the received sender timestamps and the locally generated receiver timestamps and corrects the F-Gen 116 frequency in order to regenerate the sender's clock (e.g. using a PLL, method). Frequency converter 120 is used to convert an input reference frequency F2 (10.24 MHz) to a common clock with frequency F3 (19.44 MHz in this example).

As shown in FIG. 1, there are situations in which both sender and receiver have access to an external reference clock that is traceable to the same accurate clock source but the common clock frequency at the sender and receiver are different. In the example shown, the sender has access to a 19.44 MHz clock, while the receiver has access to a 10.24 MHz clock, both traceable to the same common source clock. If both sender and receiver need to support current practice (symmetrical) differential timing, they need to agree on a common reference clock. If the agreed common reference clock is 19.44 MHz, the receiver which has a 10.24 MHz clock available will need to use a device (PLL) that converts 10.24 MHz to 19.44 MHz in order to use the 19.44 MHz as common reference clock. The need to add a PLL device to a differential timing design adds cost and complexity.

FIG. 2 describes a current practice symmetric differential timing method that supports different reference clock frequencies, referred to above as F1 and F2 (10.24 MHz and 19.44 MHz in the example given). In order to support symmetric differential timing applications, both systems need to agree on a common reference clock frequency (here F3, same as in FIG. 1). In an optional step 202, the sender, using a PLL, converts clock frequency F1 to common reference clock frequency F3. In step 204, the sender uses reference clock frequency F3 for time-stamping N cycles of a ‘service clock’, In optional step 206, the receiver uses a PLL to convert its clock frequency (F2) into common clock frequency F3. In step 208, the receiver generates a local timestamp based on F3 and N cycles of its locally generated ‘service clock’. In step 210, the receiver controls the frequency of the service clock to maintain a constant phase offset between the sender and receiver timestamps.

The main disadvantage of the current practice symmetric systems and methods is that such systems must use a frequency conversion device (e.g. a PLL) to convert between the possible common clock frequencies in order to support real life deployment scenarios. Frequency conversion between high frequency clocks while maintaining accuracy requires PLL devices, which increases the price and complexity of the system. On the other hand, if a current practice symmetric subsystem does not include such a PLL device, its applicability to various deployment scenarios will be limited compared with asymmetric differential subsystems or compared with symmetric differential subsystems that include PLL devices.

In view of the disadvantages of symmetric differential timing systems and methods described above, there is a need for and it would be advantageous to have differential timing systems and methods that do not require frequency conversion devices and do not limit the range of applications when such devices are not present

### SUMMARY OF THE INVENTION

The present invention discloses an asymmetric differential timing system and method that are superior to any symmetric differential timing systems and methods. As use herein, in some embodiments, “asymmetric” refers to differential timing using two subsystems, one having a sender and the other having a receiver that generate respective timestamps, wherein the frequency of the sender timestamps are different from (not equal to) the frequency of the receiver timestamps. In other embodiments, “asymmetric” refers to differential timing using two subsystems, each having a sender that generates respective timestamps, wherein the frequency of the timestamps of one sender are different from those of the other sender. In yet other embodiments, “asymmetric” refers to differential timing using two subsystems, each having at least one sender and at least one receiver that generate respective timestamps, wherein the frequency of the timestamps of one sender is different from that of at least one other sender or at least one other receiver.

To remove all doubt, the present invention includes embodiments in which a subsystem may include any positive number of both senders and receivers, only one sender or only one receiver.

The differential timing solution provided herein relieves the need for a frequency conversion device such as a PLL by relaxing the requirement for symmetric operation. Instead of using a PLL device as in current practice, a controller included in each subsystem uses arithmetic operations to accommodate the asymmetry of the solution. Arithmetic operations require fewer resources from the system (e.g. can be done in software) and no accuracy is lost. Therefore the present invention simplifies the cost and complexity of systems using the differential timing method without limiting the applicability of the solution only to symmetric deployment scenarios.

According to the present invention there is provided a method for reconstructing a service clock between two subsystems including steps of providing a first subsystem including a first sender and a second subsystem including a second sender and, in each subsystem, generating timestamps based on sampling of the service clock by a common clock available at both subsystems, such that a first timestamp frequency generated by the first subsystem is different from a second timestamp frequency generated in the second subsystem, whereby the non-equal timestamp frequencies define an asymmetric differential timing solution from which the service clock can be reconstructed.

According to the present invention there is provided a method for reconstructing a service clock between two subsystems including steps of providing a first subsystem including a sender and a second subsystem including a receiver, wherein both subsystems have a common clock traceable to the same source; by the sender, based on sampling of the service clock by the common clock, generating sender timestamps at a sender timestamp frequency; and, by the receiver, based on sampling of a reconstructed service clock by the common clock available at the receiver, generating local timestamps at a receiver timestamp frequency, wherein the frequency of the local timestamps is different from the sender timestamp frequency, whereby the non-equal timestamp frequencies define an asymmetric differential timing solution from which the service clock can be reconstructed.

According to the present invention there is provided a system for reconstructing a service clock between two, first and second subsystems communicating therebetween, the system including a first subsystem with a first transmission function operative to generate first subsystem timestamps at a first frequency, a second subsystem with a second transmission function operative to generate second subsystem timestamps at a second frequency different from the first timestamps, wherein the generations of both first and second timestamps are based on sampling of the service clock by a common clock available at both subsystems and an aligner for arithmetically aligning the different first and second subsystem timestamps to reconstruct the service clock.

### BRIEF DESCRIPTION OF THE DRAWINGS

For a better understanding of the present invention and to show more clearly how it could be applied, reference will now be made, by way of example only, to the accompanying drawings in which:

FIG. 1 describes a simplified current practice symmetric differential timing system;

FIG. 2 describes a current practice differential timing method that supports different reference clock frequencies;

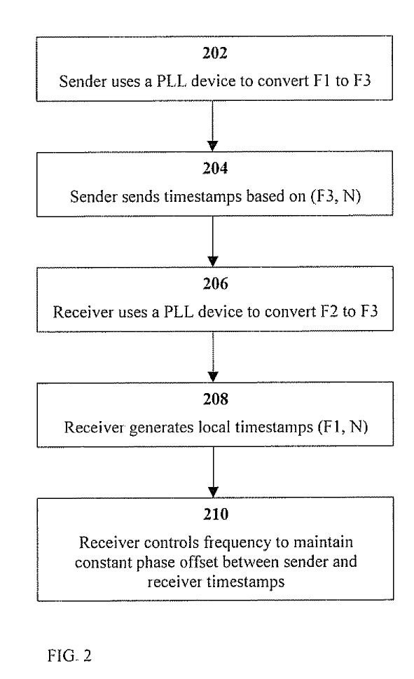

FIG. 3 describes the main steps of one embodiment of the asymmetric differential timing method of the present invention;

FIG. 4 shows an asymmetric differential timing system of the present invention that can implement the method of FIG. 3.

### DETAILED DESCRIPTION OF THE INVENTION

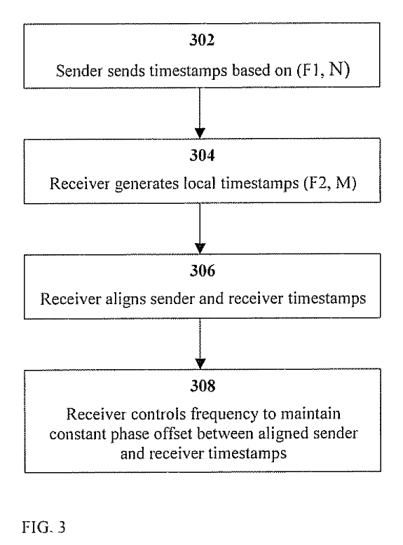

The present invention discloses an asymmetric differential timing solution in which receiver and sender in each “subsystem” as defined above use the highest available clock frequency traceable to the same source for time-stamping and in which no PLL is required to convert between different frequencies. FIG. 3 describes the main steps of one embodiment of the asymmetric differential timing method of the present invention. In step 302, a sender in a first subsystem uses a clock traceable to a common clock source with highest frequency and accuracy available to it (frequency F1) for time-stamping N cycles of a ‘service clock’, In step 304, a receiver in a second subsystem uses a clock traceable to a common clock source with highest frequency and accuracy available to it (second frequency F2) to generate local timestamps of M cycles of a locally generated ‘service clock’. In step 306, the receiver aligns local (receiver) timestamps and timestamps received from the sender to the same common time base. In step 308, the receiver controls the frequency of the service clock to maintain a constant phase offset between the aligned sender and receiver timestamps.

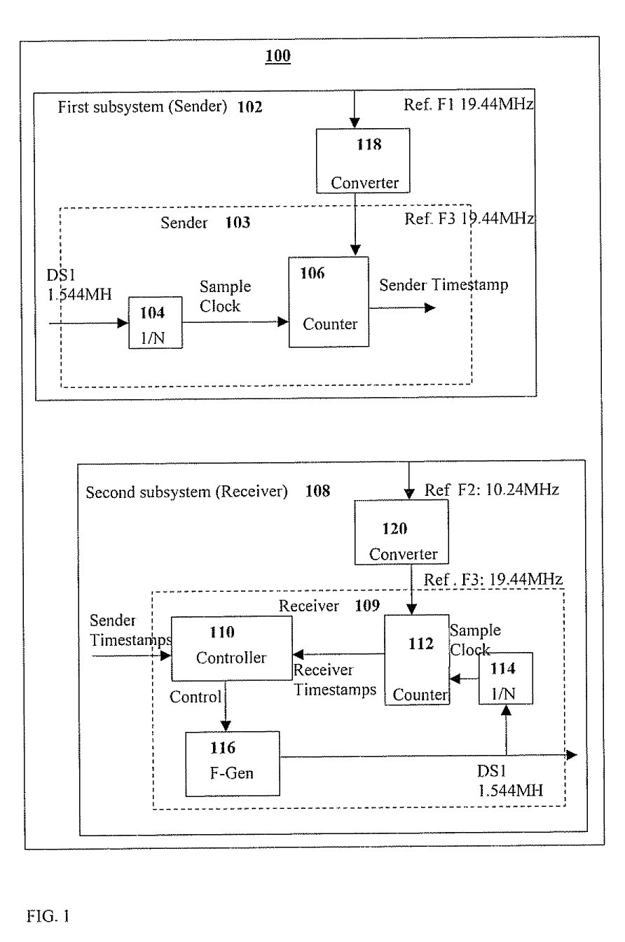

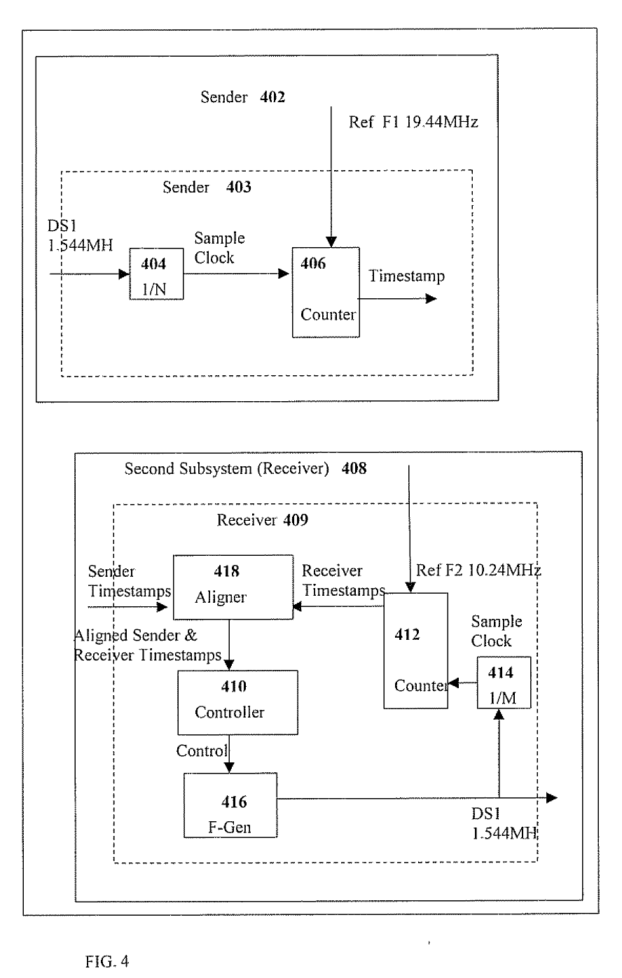

FIG. 4 shows an asymmetric differential timing system 400 of the present invention that can implement the method of FIG. 3. System 400 includes a differential timing first (sender) subsystem 402 and second (receiver) subsystem 408. The sender and receiver subsystems include many elements similar to those in FIG. 1 and in particular include a sender transmission function 403 and a receiver transmission function 409. Thus, subsystem 402 includes a 1/N divider 404 and a counter 406, interconnected as shown. Advantageously, subsystem 402 does not include (or need) a frequency converter required by sender 102 of FIG. 1. Second subsystem 408 includes a controller 410, a counter 412, a 1/M divider 414 and a controlled frequency generator (F-Gen) 416, interconnected as shown. Advantageously, subsystem 408 does not include (or need) the frequency converter as required by receiver 108 of FIG. 1. Instead, subsystem 408 includes an aligner 418 that performs the alignment of the local and received timestamps described above. Note that sender and receiver use different frequencies (F1, F2) and may use different dividers (N, M) compared with the identical values of (F3, N) as in FIG. 1.

In use, the first subsystem sender (or simply “sender”) 402 operates as before (i.e. similar to sender 102 of system 100). 1/N divider 404 generates a sample clock pulse every N cycles of the incoming service clock. Counter 406 value increments each cycle of the reference clock and, each sample clock, generates a sender timestamp which holds the counter value at that time. This sender timestamp is sent to receiver 108. However, in contrast with receiver 108, second subsystem receiver (or simply “receiver”) 408 has access to a common reference clock based on a different frequency (i.e. 10.24 MHz), Controller 410 and F-Gen 416 operate similarly to their counterparts in system 100. Counter 412 and 1/M divider 414 operate similar to counter 112 and 1/N divider 114 in system 100, except for the possibly different frequency divider (N compared with M). Aligner 418 aligns the incoming sender timestamps and the local receiver timestamps to a common time base. After the aligner performs this operation, as explained below, controller 410 can operate as in FIG. 1, achieving a constant offset between the aligned sender and receiver time-stamps.

The following example illustrates the operation of aligner 418 to align different timestamp and common clock frequencies. The ratio between the 19.44 MHz clock and the 10.24 MHz clock is 243/128. Therefore if one divides the incoming sender timestamps by 243, and divides the locally generated receiver timestamps by 128, one arrives at a common time-base for both timestamps. Since the aligner can be implemented in software, division can be implemented as an arithmetic operation and the variable storing the timestamps can be as accurate as desired. Therefore, no accuracy is lost, and no hardware frequency converter PLL needs to be used. In normal practice, all timestamp frequencies in telecom are multiples of 8 kHz (8000 cycles per second) signals. Therefore, it is always possible to align the timestamp frequencies to the 8 kHz time base. Alternatively, M and N values can be chosen such that the aligner does not need to perform any arithmetic operation at all. For example, if the ratio of N/M is equal to the ratio F1/F2, the timestamp time base will be aligned. In general, the aligner can align the time base for any combination of F1, F2, M and N in a set of simple arithmetic operations.

In summary, the present invention relieves the need for PLL devices used in current practice by relaxing the requirement for symmetric operations. Instead of using a PLL, device, a controller uses arithmetic operations to accommodate the asymmetry of the proposed differential timing solution. For the example given above, the arithmetic solution includes dividing the sender timestamps with frequency F1 and divider N by a number L1 and dividing the receiver timestamps with frequency F2 and divider M by a number L2 such that F1/(L1*N)=F2/(L2*M). Arithmetic operations require fewer resources from the system (e.g. can be done in software) and no accuracy is lost. Therefore the present invention simplifies the cost and complexity of systems using the differential timing method.

While the invention has been described with respect to a limited number of embodiments, it will be appreciated that many variations, modifications and other applications of the invention may be made. That is, while the invention has been described mostly as operating with two subsystems, the first a “sender” subsystem and the second a “receiver” subsystem, the invention is valid for many other variations involving senders and receivers. For example, the invention may work with subsystems that include either only one sender, only one receivers both sender and receiver or pluralities of senders and receivers in each subsystem. In particular, the invention covers the case in which each subsystem includes a sender, wherein the sender in one subsystem uses a different timestamp frequency to generate RTP timestamps from the sender in the other system. In the most general sense, the invention therefore covers any use of asymmetric differential timing, where the “asymmetric” aspect is defined as use of two or more subsystems, each having at least one sender, at least one receiver or both, wherein the frequency of the timestamps generated by a sender is not to the timestamp frequency generated by another sender or by another receiver.

What is claimed is:

1. In a telecom network, a method for reconstructing a service clock between two subsystems comprising steps of:
a. providing a first subsystem including a first sender and a second subsystem including a second sender; and
b. in each subsystem, generating timestamps based on sampling of the service clock by a common clock available at both subsystems, such that a first timestamp frequency generated by the first subsystem is different from a second timestamp frequency generated in the second subsystem,
whereby the non-equal timestamp frequencies define an asymmetric differential timing solution from which the service clock can be reconstructed.

2. The method of claim 1, wherein the service clock reconstruction is performed by aligning the different timestamp frequencies in an arithmetic operation.

3. The method of claim 1, wherein the step of generating timestamps includes:
i. in the first subsystem, using a first clock traceable to a common clock with a first frequency F1 for time-stamping N cycles of the service clock to generate the first timestamp frequency; and
ii. in the second subsystem, using a second clock traceable to a common clock source with a second frequency F2 for time-stamping M cycles of the service clock to generate the second timestamp frequency.

4. The method of claim 3, wherein M is equal to N.

5. A method for reconstructing a service clock between two subsystems comprising steps of:
a. providing a first subsystem including a sender and a second subsystem including a receiver, wherein both subsystems have a common clock traceable to the same source
b. by the sender, based on sampling of the service clock by the common clock, generating sender timestamps at a sender timestamp frequency; and
c. by the receiver, based on sampling of a reconstructed service clock by the common clock available at the receiver, generating local timestamps at a receiver timestamp frequency, wherein the frequency of the local timestamps is different from the sender timestamp frequency;
whereby the non-equal timestamp frequencies define an asymmetric differential timing solution from which the service clock can be reconstructed.

6. The method of claim 5, wherein the step of generating sender timestamps includes using a first clock with a first frequency F1 and traceable to the common clock for time-stamping N cycles of the service clock to generate the first timestamp frequency; and wherein the step of generating local timestamps includes using a second clock with a second frequency F2 and traceable to a common clock for time-stamping M cycles of the reconstructed service clock to generate the second timestamp frequency, whereby N and M are dividers.

7. The method of claim 6, wherein the reconstruction of the service clock further includes:
i. receiving the sender timestamps from the sender;
ii. aligning the sender and local timestamps to the common time base; and
iii. using the aligned time base to control the frequency of a frequency generator to generate the reconstructed service clock.

8. The method of claim 5, further comprising: by the receiver, performing an arithmetic aligning operation for compensating the frequency difference between the sender and local timestamp frequencies.

9. The method of claim 8, wherein performing an arithmetic operation includes dividing the sender timestamps with frequency F1 and divider N by a number L1 and dividing the receiver timestamps with frequency F2 and divider M by a number L2 such that F1/(L1*N)=F2/(L2*M).

10. The method of claim 9, wherein M is equal to N.

11. The method of claim 9, wherein M is non-equal to N.

12. In a telecom network, a system for reconstructing a service clock between two, first and second subsystems communicating therebetween, the system comprising:
a. a first subsystem with a first transmission function operative to generate first subsystem timestamps at a first frequency;
b. a second subsystem with a second transmission function operative to generate second subsystem timestamps at a second frequency different from the first timestamps, wherein the generations of both first and second timestamps are based on sampling of the service clock by a common clock available at both subsystems; and
c. an aligner for arithmetically aligning the different first and second subsystem timestamps to reconstruct the service clock.

13. The system of claim 12, wherein the first subsystem includes a sender and the second subsystem includes a receiver.

14. The system of claim 12, wherein each subsystem includes a sender.

15. The system of claim 12, wherein each subsystem includes a sender and a receiver.

16. The system of claim 12, wherein the aligner is implemented in software.

17. The system of claim 12, wherein the first subsystem further includes a 1/N divider for generating a sample clock pulse every N cycles of the service clock and a counter for value incrementing each cycle of a first subsystem reference clock and for, each sample clock, generating the first system timestamps and wherein the second subsystem further includes a controlled frequency generator (F-Gen) for generating the reconstructed service clock, a controller for controlling the frequency of the clock generated by F-Gen, a 1/M divider for generating a sample clock pulse every M cycles of the reconstructed service clock and a counter for value-incrementing each cycle of a second subsystem reference clock and for generating the second subsystem timestamps
